(19) United States
(12) Patent Application Publication
(10) Pub. No.: US 2026/0113272 A1
(43) Pub. Date: Apr. 23, 2026

(54) L4S CONGESTION CONTROL ALGORITHM FOR AP

(71) Applicant: HEWLETT PACKARD ENTERPRISE DEVELOPMENT LP, Spring, TX (US)

(72) Inventors: JIANPO HAN, Beijing (CN); MOHD SHAHNAWAZ SIRAJ, San Jose, CA (US); ANDRE BEAUDIN, Montreal (CA); OMAR EL FERKOUSS, St. Laurent (CA)

(21) Appl. No.: 18/921,411

(22) Filed: Oct. 21, 2024

(51) Int. Cl. H04L 47/12

(52) U.S. Cl. CPC H04L 47/12

(57) ABSTRACT

Systems and methods are provided for implementing enhanced Low Latency, Low Loss, and Scalable throughput (L4S) mechanisms at a bottleneck network node to detect and more accurately/selectively address congestion. Low and high watermark limits can be established for access category (AC) queues at the bottleneck network node, such as an access point (AP). Incoming packets can be analyzed to determine their priority, and then assigned to an AC queue. Depending on the state of a queue (whose thresholds can differ) packets can be marked or not marked with a “congestion experienced” (CE) indication. Additionally, if a congestion indication is received by an AP from a receiver application, but the congestion no longer exists, the AP can forgo forwarding this feedback upstream.

### BACKGROUND

A standardized network service, referred to as Low Latency, Low Loss, and Scalable throughput (L4S) meant to address congestion, follows an Explicit Congestion Notification (ECN) scheme at the Internet Protocol (IP) layer. Similar to what is referred to as the “Classic” (or original) ECN approach, L4S also leverages ECNs, but does so using scalable congestion control. In accordance with the L4S standard, congestion notification messages are sent by a receiver application back to the sender application indicating that somewhere downstream in the data path, congestion is occurring/has occurred. In this way, a feedback loop is created so that the congestion can be addressed.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates one example of a network/network configuration in which examples of the disclosed technology may be implemented to effectuate congestion control.

FIG. 2A illustrates an example IP datagram in which congestion can be indicated.

FIG. 2B illustrates an example scenario in which congestion control feedback may be exchanged between receiver and sender applications.

FIG. 3 illustrates an example implementation of access category queues in accordance with examples of the disclosed technology.

FIG. 4 illustrates an example of the avoidance of unnecessary congestion notifications in accordance with examples of the disclosed technology.

FIG. 5 is an example computing component that may be used to implement various features of L4S congestion control in accordance examples of the disclosed technology.

FIG. 6 is a computing component that may be used to implement examples of the disclosed technology.

The figures are not exhaustive and do not limit the present disclosure to the precise form disclosed.

### DETAILED DESCRIPTION

As noted above, the L4S service/standard can be used to address network congestion by implementing a congestion indication marking and feedback scheme. However, implementation guidelines for L4S are generic, and do not provide specific mechanisms to detect and signal congestion in a Wi-Fi environment. Additionally, the L4S standard does not contemplate managing congestion scenarios that involve multiple application flows or sessions, which can traditionally result in, e.g., marking all application flows/sessions as experiencing congestion, reducing the overall throughput across all sender applications. Moreover, low bandwidth sessions such as voice calls, do not tend to contribute to congestion. Thus throttling voice traffic would not significantly reduce congestion.

Furthermore, channel congestion can appear/disappear quickly, and controlling congestion that no longer exists leads to unnecessary fluctuations in network performance/network resource utilization. That is, given the variable nature of Wi-Fi, APs may encounter temporary instances of channel congestion, which per the conventional implementation of the L4S standard, could result in an AP marking the session as having experienced congestion. Yet, if the channel quickly becomes free again, a sender may have already throttled its transmission rate, leading to the aforementioned, unnecessary fluctuations in network performance/resource utilization.

Further still, in a multi-hop network, multiple nodes may mark an application flow with a congestion indicator. Difficulties can arise when attempting to correlate or associate receipt of a congestion indication packet with the actual occurrence of congestion at a node(s).

In the Wi-Fi context, access points (APs) tend to be bottleneck nodes where congestion occurs/develops. Given an AP's visibility into network traffic (which traverses APs), examples of the disclosed technology are directed to adapting L4S for APs, e.g., implementing enhanced L4S mechanisms at the AP to detect and more accurately/selectively address congestion. Low and high watermark limits can be established for access category (AC) queues at the AP. Incoming packets can be analyzed to determine their priority, and then assigned to an AC queue. Depending on the state of a queue (whose thresholds can differ) packets can be marked or not marked with a “congestion experienced” (CE) flag per the L4S standard. Additionally, if a congestion notification or indication is received by an AP from a receiver application, but the congestion no longer exists, the AP can drop the congestion notification to keep it from ever reaching the sender application. In this way, an ECN scheme or mechanism can be selectively applied to different types of traffic, taking into account, current application flow characteristics (e.g., time of data packet travel between network nodes), and current/real-time state of congestion in the network.

The IEEE 802.11 family of standards for wireless local area network (WLAN) technology, also referred to as Wi-Fi, typically include Quality of Service (QoS) extensions that can manage prioritization based on the type of data. For example, QoS extensions for some 802.11 protocols may prioritize the transmission of voice packets and video packets. Particularly, Wi-Fi Multimedia (WMM), previously known as Wireless Multimedia Extensions (WME), is a subset of the 802.11e wireless LAN (WLAN) specification that enhances QoS on a network by prioritizing packets according to four access categories (AC). According to WMM, the access categories (arranged from highest priority to lowest) include:
1) Voice: By giving voice packets the highest priority, WMM enables concurrent Voice over IP (VoIP) calls with minimal latency and the highest quality possible;
2) Video: By placing video packets in the second tier, WMM prioritizes it over all other data traffic and enables support for three to four standard definition TV (SDTV) streams or one high definition TV (HDTV) stream on a WLAN;
3) Best effort: Best effort data packets consist of those originating from legacy devices or from applications or devices that lack QoS standards; and
4) Background: Background priority encompasses file downloads, print jobs and other traffic that does not suffer from increased latency.

Each of the aforementioned WMM access categories represents a different WLAN transmit and/or receive (Tx/Rx) policy. WMM also defines how Differentiated Services Code Point (DSCP) values can be mapped into those access categories. For example, when traffic flows, consisting of related data packets, comes from a wired network to a wireless client, the WMM maps DSCP values to certain access categories so that packets which contain different DSCP values, are routed to different transmission queues.

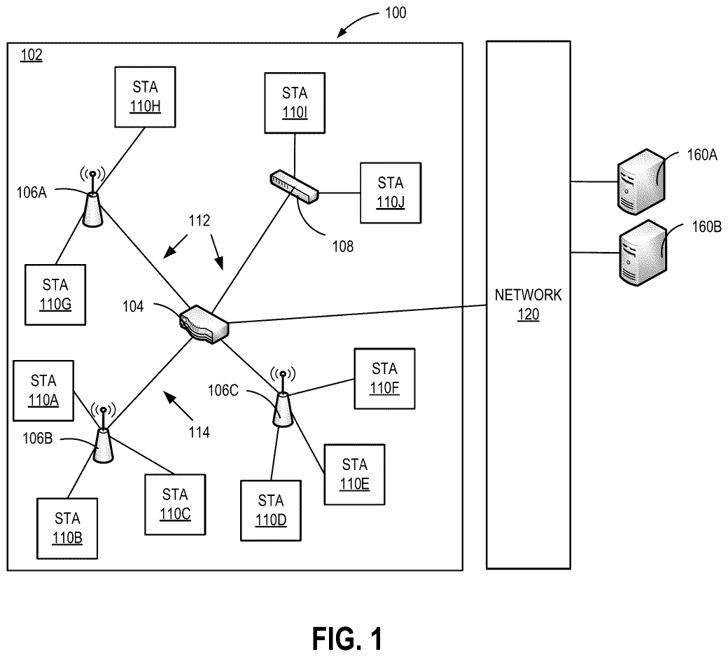

Before describing embodiments of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility or other organization. FIG. 1 illustrates an example of a configuration implemented with an organization having multiple users (or at least multiple client devices 110) and one or more sites. As an example, network configuration 100 may include a site 102 in communication with a network 120.

Site 102 may include a primary network, which may be an office network, home network, or other network installation, for example. The primary network may be a private network, such as a network that may include security and access controls to restrict access to authorized users of the private network. Authorized users may include employees of a company at site 102, residents of a house, customers at a business, for example.

In the example of FIG. 1, site 102 includes a controller 104, which is in communication with the network 120. The controller 104 may provide communication with the network 120 for site 102. There may be other points of communication with the network 120 for site 102 in addition to controller 104. Although single controller 104 is illustrated, the primary site 102 may include multiple controllers and/or multiple communication points with network 120. In some embodiments, the controller 104 may communicate with the network 120 through a router. In other embodiments, the controller 104 provides router functionality to the devices in site 102. In this specification, the word “tunnel” refers to an encapsulated mode of transporting data between AP and controller.

The controller 104 may be operable to configure and manage network devices, such as at site 102. The controller 104 may be operable to configure and/or manage switches, routers, access points, and/or client devices connected to a network. The controller 104 may itself be, or provide the functionality of, an Access Point (AP).

The controller 104 may be in communication with one or more switches 108 and/or wireless Access Points (APs) 106a-c. Switches 108 and wireless APs 106a-c provide network connectivity to various client devices or stations (STAs) 110a-j. Using a connection to a switch 108 or AP 106a-c, a STA 110a-j may access network resources, including other devices on the (site 102) network and the network 120.

Examples of STAs may include: desktop computers, laptop computers, servers, web servers, authentication servers, authentication-authorization-accounting (AAA) servers, domain name system (DNS) servers, dynamic host configuration protocol (DHCP) servers, internet protocol (IP) servers, virtual private network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, internet of things (IOT) devices, and the like.

Within site 102, a switch 108 is included as one example of a point of access to the network established in site 102 for wired STAs 110i-j. STAs 110i-j may connect to the switch 108 and through the switch 108, may be able to access other devices within the network configuration 100. STAs 110i-j may also be able to access the network 120, through the switch 108. STAs 110i-j may communicate with the switch 108 over a wired or wireless connection 112. In the illustrated example, the switch 108 communicates with the controller 104 over a wired or wireless connection 112.

Wireless APs 106a-c are included as another example of a point of access to the network established in site 102 for STAs 110a-h. Each of APs 106a-c may be a combination of hardware, software, and/or firmware that is configured to provide wireless network connectivity to wireless STAs 110a-h. In the example of FIG. 1, APs 106a-c can be managed and configured by the controller 104. APs 106a-c communicate with the controller 104 and the network over connections 112, which may be either wired or wireless interfaces. In examples of the present application, APs, which can be bottlenecks in a Wi-Fi network, can be implemented with AC-specific queues, according to which, the marking of packets as experiencing congestion, can be selectively performed. As can be appreciated, APs, such as APs 106a-c service a plurality of STAs, where traffic to/from such STAs traverse APs. Thus, as noted above, the visibility that an AP has within the network can be leveraged to enhance or further specify the operation or use of L4S in a Wi-Fi scenario.

The network 120 may be a public or private network, such as the Internet, or other communication network to allow connectivity within site 102, or with other sites (e.g., secondary sites (not shown)). The network 120 may include third-party telecommunication lines, such as phone lines, broadcast coaxial cable, fiber optic cables, satellite communications, cellular communications, and the like. The network 120 may include any number of intermediate network devices, such as switches, routers, gateways, servers, and/or controllers, which are not directly part of the network configuration 100 but that facilitate communication between the various parts of the network configuration 100, and between the network configuration 100 and other network-connected entities. The network 120 may include various servers 160a-b. In an example, servers 160a-b may comprise content servers that include various providers of multimedia downloadable and/or streaming content, including audio, video, graphical, and/or text content, or any combination thereof. Examples of content servers 160a-b include web servers, streaming radio and video providers, and cable and satellite television providers. STAs 110a-j may request and access the multimedia content provided by the content servers 160a-b.

As is known, Wi-Fi traffic (or other types of traffic, e.g., Internet traffic) comprises packets, i.e., small segments or pieces of data that are sent over a Wi-Fi network by a sender application/client device. A receiver application/client device may then reassemble received packets. Wi-Fi traffic can encompass various types of packets, e.g., data packets (the packets containing actual data to be forwarded from wireless to wired networks), management packets (for joining a basic service set (BSS) and discovering APs or other base stations, and control packets used to, e.g., acknowledge successful receipt of a packet(s), or reserving a communications medium. Examples described herein will refer to packets (meaning data packets) being assigned to particular queues that can be used to determine whether or not to mark a packet with a congestion indicator, although examples of the disclosed technology can be adapted to optimize the transmission of other types of packets or communications.

At times, one or more parts of a network (e.g., nodes of the network) may not be able to quickly service packets that have arrived because a user, or application, or device transmits more packets than that part of the network can handle. An AP is an example of such a network node. APs can become bottlenecks in a network due to APs serving multiple STAs, having multiple radios, etc. When the rate at which packets arrive (e.g., at an AP) exceeds the rate at which packets can be served (e.g., transmitted or forward from the AP), latency is introduced.

Conventional congestion control mechanisms, such as classic Transmission Control Protocol (TCP) control may attempt to address or mitigate the introduction of or increase in latency by reducing the transmission rate of packets. Alternatively, the L4S standard uses a bit in the IP header of a packet as an explicit congestion signal that can be used to identify the existence of congestion to a sender. The sender may then react to adjust or tune its packet transmission rate.

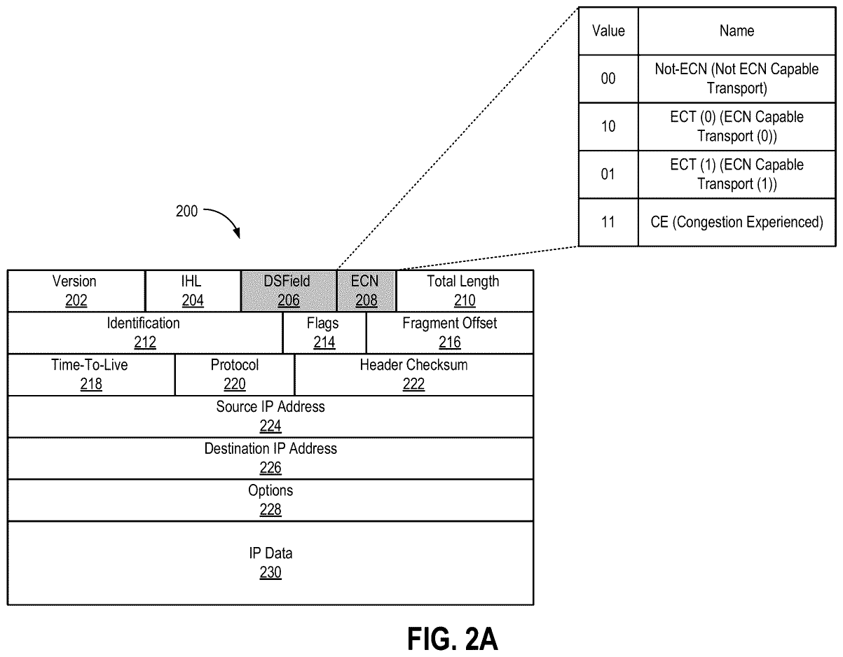

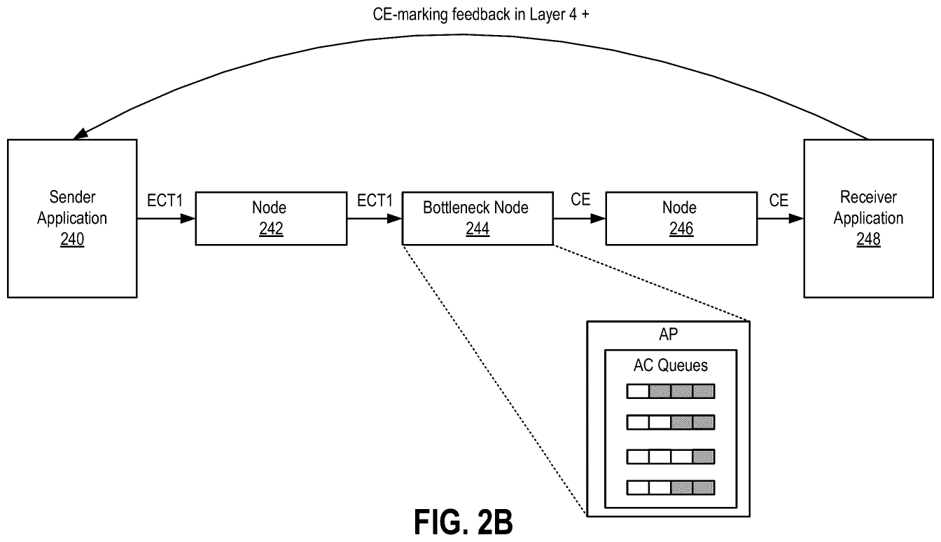

FIG. 2A illustrates an example of an IP datagram 200 and its IPv4 header format that accounts for the use of an ECN scheme (although it should be understood that use of ECN is not limited to systems reliant on IPv4, e.g., ECN can be used with IPv6). As illustrated in FIG. 2A, the header format of IP datagram 200 may include bits representing a version 202 of the header, in this case, 4 bits representative of IPv4, and an Internet Header Length (IHL) field 204 used to indicate how many 32-bit words are present in the header. A DSCP (also referred to as Type of Service (ToS) field 206 can be used to reflect features related to QoS (e.g., to specify how a datagram is to be handled). ECN field 208 is used to send congestion notifications to a sender or receiver when network congestion exists. A total length field 210 can be used to denote the size of an IP datagram, while an identification field 212/flags field 214 can be used to identify the fragments or portions of the IP datagram. A fragment offset field 216 can specify the offset of a fragment relative to the start of the IP datagram, a Time-To-Live (TTL) field 218 indicates the maximum time the IP datagram will be “live” in the network, and protocol field 220 denotes the protocol used in the data portion of the datagram (e.g., TCP, UDP, and so on). A header checksum field 222 checks the header for any errors by comparing its value to that of its checksum at each hop. Mismatch results in a packet being discarded. Source IP address field 224 signifies the 32-bit address of the source of the packet, while the destination IP address field 226 reflects the receiver's 32-bit address. Options field 228 is an optional field that can be used when the IHL is set to more than five. IP data field 230 carries the data payload of the packet.

Referring back to ECN field 208, as further illustrated in FIG. 2A, the value specified in ECN field 208 can include values reflecting ECN state, i.e., whether or not a packet is an ECN-capable packet, and whether or not congestion has been experienced. Instead of dropping a packet (as would be the case without ECN), an ECN-aware network node/router may set a mark in the IP header of the packet as a way to signal impending congestion. That is, congestion is typically addressed by the sender of packets. However, because congestion is known to have happened only after a packet was sent, an “echo” of the congestion indication sent by a receiver to a sender. Without ECN, the detection of lost packets (vis-a-vis the dropping of packets) acts as the congestion indication echo. With ECN, congestion can be indicated by setting the ECN field of a packet to CE, which may then be echoed back to the sender/transmitter by the receiver by setting the proper bits in the header of the packet.

As illustrated in FIG. 2A, ECN uses ECN field 208 to encode four code points. Code point “00” can be used to signify that the packet is not an ECN-capable transport. Code points “01”/“10” an be used by endpoints (sender/receiver) that support ECN to mark their packets. It should be noted that network nodes treat code points 01 and 10 the same/as equivalents. Code point “11” signifies congestion when a packet traverses a queue (as will be described in greater detail below) that is experiencing congestion. In such a scenario, and in accordance with one example of the disclosed technology, the bottleneck AP (which supports ECN) in which the queue is implemented can change the code point from 01 or 10 to 11 instead of dropping the packet. This action/process is referred to as the aforementioned marking of the packet. The marking informs the to-be receiver node of impending congestion (gleaned from the state of the queue). The receiver, upon receipt of the packet marked as CE, will handle the CE indication with an upper layer protocol, e.g., the transport layer protocol, and will echo back the congestion indication to the sender so that the sender may take action/remediation operations, such as reducing its transmission rate. It should be understood that while conventional systems and methods that leverage ECN can implement active queue management, such conventional queuing is not AC-specific, nor are dynamic thresholds incorporated.

FIG. 2B illustrates an example implementation of L4S to optimize traffic flow by marking packets when congestion (due to, e.g., channel congestion or interference) is experienced, so that a receiver can send congestion feedback to the sender. The sender may then react to the congestion feedback, and appropriately adapt or alter the manner in which packets are transmitted to account for the identified congestion. It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

More particularly, in the example scenario of FIG. 2B, a sender application 240 may be transmitting packets (in accordance with a Wi-Fi session) to receiver application 248. It should be noted that a session generally can refer to a time frame of communication between two or more communication devices, in this example, between sender and receiver applications 240 and 248, respectively. Typically, a session (or network connection) can be defined or identified by a set of five values (referred to as a 5-tuple) that uniquely identify the session/network connection. Assuming that sender application 240 is ECN-capable, sender application 240 may set the ECN bits/code point of packets belonging to the session to ECT1/ECT0 indicating its compatibility with the ECN protocol. The packets may traverse a first node 242, which may forward the packet on to network node 244, which may be a bottleneck node causing congestion, e.g., an AP. As will be described in greater detail below, bottleneck node 244 may comprise an AP in which AC-specific queues are implemented to determine the existence of congestion. Upon experiencing congestion, bottleneck node 244 may change the code point from ECT1 to CE signifying impending congestion.

Bottleneck node 244 may forward the packets (after being queued appropriately) with the CE code point to, in this example, another node 246 in the network. Node 246 may also forward the packets on to receiver application 248 (the ultimate recipient of the packets and with whom the session is established) with their CE code point.

Upon receipt of packets indicating that congestion has been experienced, receiver application 248 can echo back the congestion experienced indication to sender application 240. In this way, sender application 240 can address the congestion, e.g., by reducing its packet transmission rate (e.g., to alleviate congestion, which can be reflected by the AC-specific queue threshold state). It should be noted that the CE-marking feedback that is echoed by sender application 248 back to sender application 240, is illustrated as bypassing nodes 242-246 only for clarity's-sake. That is, in practice, the CE-marking feedback handled by the upper layers, e.g., layer 4 or higher (of the Open Systems Interconnection model) layers can be transmitted back to sender application 240 via non-data packet communications, e.g., via management packets or control packets. Those layers can be the transport layer, the session layer, the presentation layer, or the application layer.

Congestion on APs can generally be attributed to high channel utilization or interference with other wireless networks. Due to this high channel utilization or interference, backoff intervals (a random time interval that a network node waits before retransmitting a data packet after a collision) are lengthened, and the number of packet transmission retries increases. The longer backoff intervals and increased retries can result in channel congestion. In accordance with examples of the disclosed technology, bottleneck nodes, such as APs can mark a packet with a CE code point based on the delta (between an arrival timestamp associated with receipt of a packet from a network interface of the AP and the actual transmission timestamp of the packet) being indicative of delays. In this way, an AP can keep track or maintain a moving average metric for an application flow or session traversing the AP. For example, an AP can timestamp a packet upon the packet's arrival over a wireless interface, as well as when a successful transmit-completion indication (an acknowledgement or ACK) is received for that packet. It should be noted that by considering the delta between arrival of a packet and completed transmission/successful receipt of the packet, packet retry transmissions can also be accounted for (since only successful transmission/receipt of a packet is timestamped, rather than simply when the packet is transmitted or forwarded to a next network node). A large delta (“large” being configurable or variable depending on the network, desired network QoS, etc.) generally indicates network congestion.

In accordance with some examples of the disclosed technology, the enhanced L4S implementation may provide two methods of operation to detect and signal congestion in an application flow or session.

A first method can be a reactive method, whereby congestion is signaled by an AP only when the AP experiences channel congestion. That is, even if the AP receives a packet marked with CE from an upstream network node/sender application, the AP will not mark the packet upon transmitting the packet unless the AP itself experiences channel congestion. As described above, an AP can determine the existence of congestion in an application flow or session by timestamping a packet upon arrival at the AP and upon successful transmission of the packet from the AP/receipt at a downstream network node or the receiver application. The AP can determine the difference between these two timestamps, and if the difference is large enough, the AP may consider the application flow/session to be experiencing congestion. Again, what constitutes a “large” timestamp difference can vary.

A second method can be a proactive method, whereby congestion can be determined based on the state of AC-specific queues implemented at the AP. In accordance with this proactive method, low and high thresholds can be set for AC-specific queue depths. The low and high thresholds can be bases for whether or not the AP marks a flow with a CE code point indicating congestion. Due to the determination being based on threshold queue depths, the traffic flow can be smoothened out, and unnecessary jitter can be avoided. In other words, the AC-specific queues with their low and high thresholds can signal impending congestion, and the AP can apply mitigation/remediation measures to control/ease the impending congestion. Regarding the AC-specific queues, the low and high thresholds for video (VI) and voice (VO) application flows or sessions will typically be set higher than those for the best effort (BE) and the background (BK) application flows/sessions.

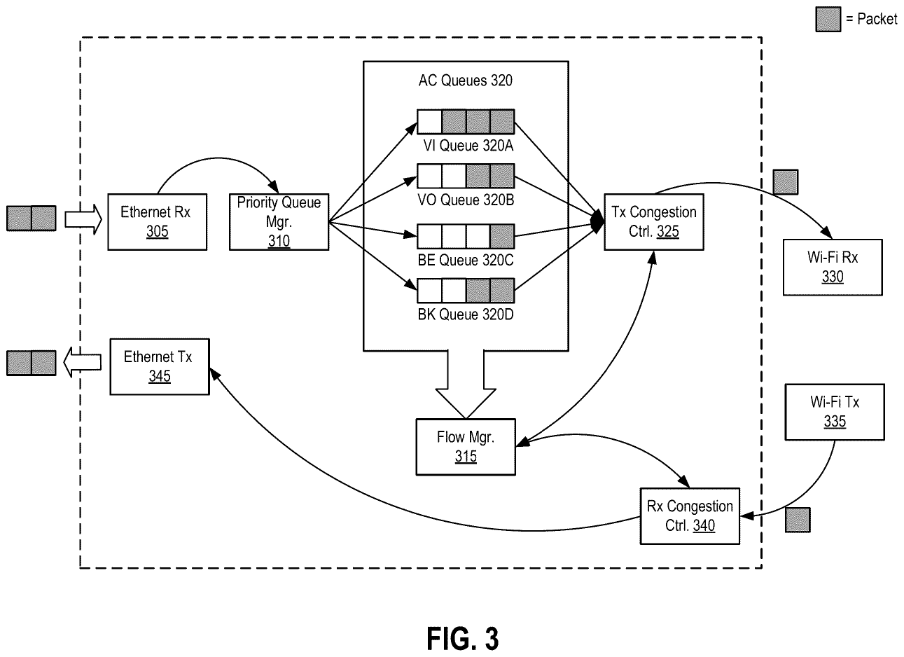

FIG. 3 illustrates an example implementation of AC-specific queues in an AP (or other network node, such as an AP controller or router through which traffic traverses) for improved L4S implementation.

As illustrated in FIG. 3, an AP 300 may comprise network interfaces, such as Ethernet interfaces, in particular an Ethernet receive interface 305 and an Ethernet transmit interface 345. Ethernet receive interface 305 and Ethernet transmit interface 345 may make up a network interface card that allows devices, in this case, AP 300, to connect to an Ethernet network. Packets, such as packets from a sender application (e.g., sender application 240 of FIG. 2B) may be received at Ethernet receive interface 305.

Upon receipt of a packet, a priority queue manager 310 determines the priority of that packet, and assigns it to one of four AC queues based on the determined priority. For example, the sender application may set a DSCP value for its packets, based on the application's specifications. Upon the traffic flow entering AP 300 from the sender application (referred to as an application flow), priority queue manager 310 may use the DSCP value to determine a Traffic ID (TID) that can be assigned to the traffic flow, which the priority queue manager 310 uses to map the packet and other data packets constituting the traffic flow, to a queue corresponding to one of the ACs (VI, VO, BE, BK). Thus, the packets, being in the different transmission queues, can be transmitted in accordance with different WLAN transmission policies of the ACs.

As illustrated in FIG. 3, a plurality of AC queues 320 may be implemented in AP 300, in particular a VI queue 320A, a VO queue 320B, a BE queue 320C, and a BK queue 320D. Depending on the priority determined by priority queue manager 310, packets received at Ethernet receive interface 305 can be assigned to one of AC queues 320. As noted above, each of these AC queues 320 has its own low and high thresholds for congestion control. These thresholds are the bases for determining when to start or when to stop marking packets with CE flags/code points in the AC queues 320. When the number of packets in an AC queue exceeds the high threshold for that AC queue, packets transmitted from AP 300 can be marked with CE flags/code points, and congestion control mechanisms may be applied to manage packet loss or delay, e.g., tail-dropping and active queue management. When the number of packets in an AC queue is below that of the low threshold, AP 300 ceases marking packets to be transmitted with the CE flag/code point. It should be understand that AC queues 320 still operate as conventional packet transmission queues in that when AP 300 is unable to service an incoming packet from Ethernet receive interface 305, that packet in placed in an appropriate one of VI queue 320A, VO queue 320B, BE queue 320C, or BK queue 320D awaiting an opportunity to be transmitted.

Determining and adjusting the low and high thresholds can be based on weights associated with channel quality and traffic load, ensuring that the CE marking (or lack of CE marking) comports with and adapts to current RF conditions and AP state. In some examples, RF metrics can be monitored, e.g., channel utilization, and retransmission rate. High channel utilization can suggest/indicate congestion on the channel, while high retransmission rate also signals congestion issues. When RF conditions are “good” the low threshold is set to be higher to allow for more traffic to be transmitted, but when RF conditions are “poor,” the low threshold is set lower to trigger congestion control earlier. The high watermark can be set higher to avoid frequent congestion control actions when RF conditions are good, and the high watermark can be set lower to quickly reduce congestion when RF conditions are poor. It should be noted that the terms good and poor are relative, and configurable/variable depending on, e.g., desired/desirable QoS/QoE or conditions, type of network, etc.

After packets are queued in an appropriate one of AC queues 320, the packets are processed by transmit congestion control module 325. Transmit congestion control module 325 may check the depth of an AC queue, e.g., one of AC queues 320, to determine if either the low threshold (a low queue depth threshold) is unmet or the high threshold (a high queue depth threshold) is exceeded. If the high threshold is exceeded, transmit congestion control module 325 marks packets to be transmitted with CE flags. Transmit congestion control module 325 may further instruct a flow manager 315 (described below) to set an internal AP 300 flag indicating the existence of congestion. If the queue depth of an AC queue falls below the low threshold for that particular AC queue, transmit congestion control module 325 may instruct flow manager 315 to clear the internal AP 300 flag. It should be noted that packets can start to accumulate in an AC queue as a result of transmission delays, which as described above, can be measured by calculating the delta between a packet arrival timestamp and a successful transmission timestamp. Queue depth-based congestion determinations can be made when AP 300 is operating in a proactive (versus reactive) mode of operation.

Transmit congestion control manager 315 may keep track of active flows (based on a 5-tuple) whose packets are marked with the CE flag/code point. As noted above, transmit congestion control manager 315 may also control the setting/clearing of an internal AP congestion flag depending on calculated deltas between packet arrival time and successful packet receipt, as well as queue depth.

When a packet is transmitted by AP 300, the packet may be received by a Wi-Fi receive interface 330 of a STA/client device. When AP 300 receives a packet, e.g., a packet transmitted by a receiver application (from its own Wi-Fi transmit interface 335) sending/echoing back CE marking feedback to the sender application, the packet may be received by receive congestion control module 340. If the received packet is marked with a CE flag or code point, receive congestion control module 340 may query flow manager 315 to determine if congestion is still being experienced. Depending on the response to the query received from flow manager 315, receive congestion control module 340 may either drop the CE marking feedback packet (preventing it from progressing past AP 300), or it may forward the CE marking feedback packet to a subsequent network node en route to the sender application.

In cases where multiple L4S-capable application flows or sessions are running in parallel/concurrently, examples of the disclosed technology can determine which application flow/session is using the most bandwidth. It should be noted that application flows/sessions can be identified by 5 tuple information (source IP address, destination IP address, source port, destination port, and transmission protocol), where traffic statistics are associated with each application flow/session, such as how many packets and bytes have been sent/receiver per second, for example. This can be performed/handled by a flow manager, e.g., flow manager 315. Upon determining which application flow/session of the concurrently running application flows/session is consuming the most bandwidth, the packets associated with that application flow/session can be marked with the CE flag/code point. In some examples, more than a single application flow/session can be determined to be consuming the most bandwidth (or more bandwidth than is desired), and therefore throttled.

That is, and contrary to conventional L4S operation, where, e.g., all application flows or sessions would be marked as experiencing congestion, congestion control via the use of ECN can be selectively applied. As noted above, marking all application flows as experiencing congestion would have the undesirable result of all sender applications unnecessarily reducing their packet transmission rate. Marking sessions, like voice calls, would also be undesirable given that application flows for low bandwidth applications or services corresponding to the VO access category do not generally contribute to congestion in any significant way. Thus, marking application flows or sessions that consume the most bandwidth would result in examples of the disclosed technology selecting at least one of BE or BK application flows for congestion experienced marking.

In light of the above, given that VO (and VI) traffic are typically characterized by low bandwidth consumption, the high queue depth threshold for the VO and VI AC queues can be configured to be higher than that for the BE and BK AC queues. Likewise, the low queue depth threshold for the VO and VI AC queues can be configured to be lower than those for the BE and BK AC queues, meaning it would be “easier” to meet the conditions for clearing CE flags or not marking packets with the CE flag.

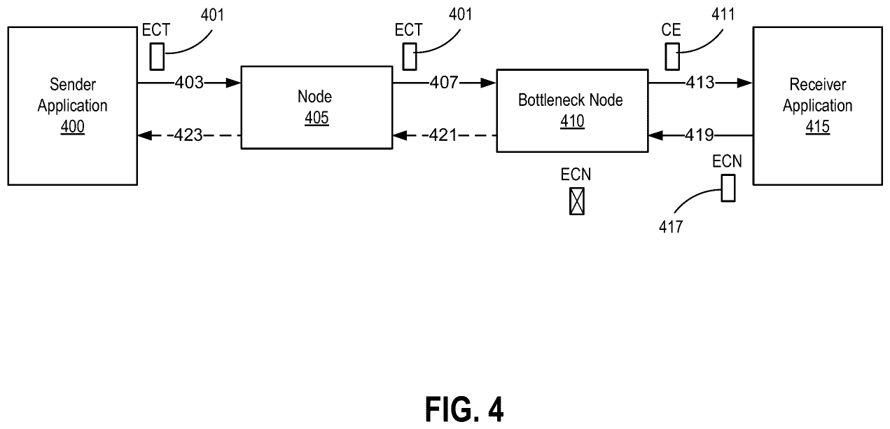

Another departure from the conventional manner in which L4S is performed or operationalized is the ability of the disclosed technology to avoid unnecessary congestion signaling. FIG. 4 illustrates an example of this avoidance of unnecessary congestion signaling in accordance with the disclosed technology. As illustrated in FIG. 4, a sender application 400 may transmit packets belonging to a particular application flow or session to receiver application 415. The packets traverse a node 405, as well as a bottleneck node 410 at which congestion is experienced by packets as they travel downstream to receiver application 415. Accordingly, sender application 400 may tag or mark the packets of its application flow to indicate it is ECN-capable by setting an ECT code point 401 in the IP header of those packets, and transmitting those packets along data path 403. Node 405 can receive and forward those packets (along data path 407) on to bottleneck node 410, such as an AP (or other L4S-capable device/element), where congestion happens to occur.

That is, and as discussed above, bottleneck node 410 may assign timestamps to incoming packets and may further assign timestamps to those same packets upon their successful transmission to receiver application 415/receipt by receiver application 415. Based on the delta between the assigned timestamps, bottleneck node 410 may determine that congestion is occurring, and may set the ECN code point to CE and queue the packet(s). Those packets with the CE code point 411 can be sent, when appropriate to receiver application 415 along data path 413. In response, receiver application 415 will echo back the CE feedback to sender application 400 by transmitting a packet with an ECN marking 417 along control path 419. In echoing back the CE feedback, the control/management packet will traverse bottleneck node and node 405 upstream, back to sender application 400.

However, as described above, when an AP, such as bottleneck node 410 receives a packet transmitted by a receiver application sending/echoing back CE marking feedback in the packet to the sender application, the packet may be received by a receive congestion control module of bottleneck node 410. If the received packet is marked with an ECN 417, the receive congestion control module may query a flow manager of bottleneck node 410 to determine if congestion is still being experienced. Depending on the response to the query received from the flow manager, the receive congestion control module may either drop the ECN from the packet or it may forward packet to a subsequent network node with the ECN, in this case, node 405, en route to the sender application, in this example, sender application 400. In the event that congestion is no longer being experienced, the ability to drop the ECN when forward the control/management packet back to sender application 400 via control paths 421/423. In this way, changes to congestion status can be realized and handled appropriately, whereas in the conventional implementation of L4S, the ECN would have been forward back to sender application 400, and sender application 400 would have addressed the signaled (but now, no longer existing) congestion by throttling its packet transmission rate unnecessarily, and further provide a more stable experience with less service fluctuations.

In the case of a multi-hop network, such as a network with a mesh topology, packets of an application flow may traverse multiple nodes in the network that may mark an application flow with a CE code point if congestion is experienced at that link or portion of the data path. Thus, being able to correlate a CE feedback packet to the location of congestion would be useful, again to avoid unnecessary CE signaling and fluctuations in service. When a bottleneck node or AP receives a packet(s) marked with CE, congestion is occurring/has been experienced elsewhere in the network, e.g., at another network node. In this event, the bottleneck node or AP can expect to receive a feedback packet with an ECN, and the bottleneck node or AP will forward that feedback packet on to other network nodes/the sender application, as usual (as described above). In the event that a bottleneck node or AP marks a packet(s) with the CE code point (meaning congestion thus far, has only occurred at the AP/link between the AP and a preceding network node), the bottleneck node or AP can record this marking operation for the current session or application flow. At some future time, the bottleneck node/AP will receive an ECN-marked packet indicating CE feedback. By reviewing its records, the bottleneck node/AP can determine that the congestion feedback is related to the congestion experienced at the AP/link between the AP and the preceding network node. In this way, if the AP determines that congestion along previous links/at previous nodes has cleared, the bottleneck node or AP can drop the ECN from the feedback packet that it will send back upstream towards the sender application.

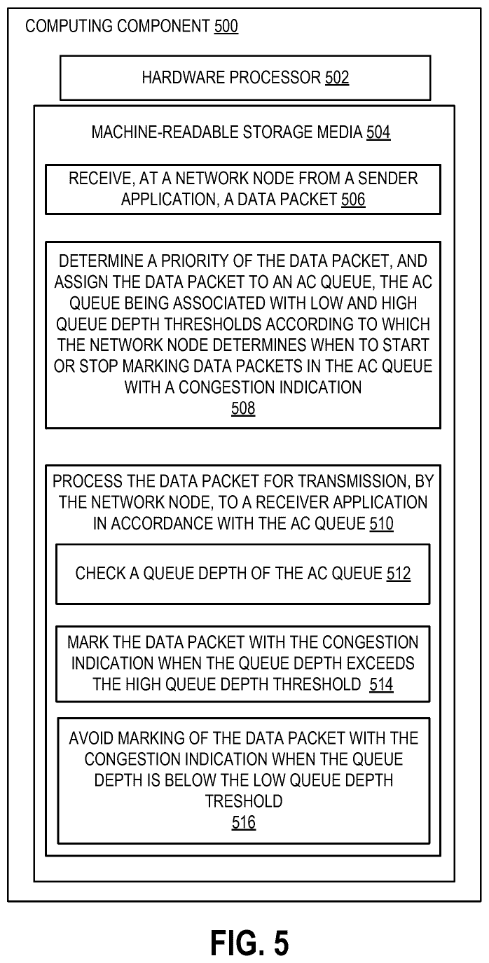

FIG. 5 illustrates a computing component that may be used to implement burst preloading for available bandwidth estimation in accordance with various examples of the disclosed technology. Referring now to FIG. 5, computing component 500 may be, for example, a server computer, a controller, or any other similar computing component capable of processing data. In the example implementation of FIG. 5, the computing component 500 includes a hardware processor 502, and machine-readable storage medium 504.

Hardware processor 502 may be one or more central processing units (CPUs), semiconductor-based microprocessors, and/or other hardware devices suitable for retrieval and execution of instructions stored in machine-readable storage medium 504. Hardware processor 502 may fetch, decode, and execute instructions, such as instructions 506-516, to control processes or operations for burst preloading for available bandwidth estimation. As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 504, may be any electronic, magnetic, optical, or other physical storage device that contains or stores executable instructions. Thus, machine-readable storage medium 504 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 504 may be a non-transitory storage medium, where the term “non-transitory” does not encompass transitory propagating signals. As described in detail below, machine-readable storage medium 504 may be encoded with executable instructions, for example, instructions 506-516.

Hardware processor 504 may execute instruction 506 to receive, at a network node, from a sender application, a data packet. As described herein, packets from a sender application can traverse a network, including nodes of that network en route to a receiver application. The data packet belongs to an application flow or session associated with the sender application.

The data packet will inevitably traverse at least one AP, which as described above, can be a bottleneck node. Upon receipt of the data packet, hardware processor 504 may execute instruction 508 to determine a priority of the data packet, and assign the data packet to an AC queue. The AC queue can be associated with low and high queue depth thresholds according to which the network node determines when to start or stop marking data packets in the AC queue with a congestion indication. That is, examples of the disclosed technology seek to improve upon conventional implementations or use of the L4S service/standard by detecting congestion and addressing detected congestion in a more selective manner. As described above, an AP may comprise a plurality of AC queues, one for each AC (VO, VI, BE, and BK). Upon receipt of the data packet, based on received DSCP values, the AP/network node can assign the data packet to a corresponding AC queue. The low and high queue depth thresholds can be set or configured/adjusted dynamically, as described herein, to account for the dynamicity of network conditions, as well as packet transmission retries.

Hardware processor 502 may execute instruction 510 to process the data packet for transmission, by the network node, to a receiver application in accordance with the AC queue. That is, upon being assigned to an appropriate AC queue corresponding to the data packets priority, hardware processor 502 may execute instruction 512 to check a queue depth of the AC queue (to which the data packet was assigned). It should be understood that queue depth refers to how “full” or occupied that AC queue is, i.e., how many packets are currently queued in the AC queue.

Hardware processor 502 may mark the queued data packet with the congestion indication when the queue depth exceeds the high queue depth threshold. The congestion indication, as described above, can be a ECN code point reflecting congestion being experienced, i.e., a CE code point or flag in the data packet's IP header. It is this congestion indication that can be forwarded to the receiver application, and which the receiver application will use to provide feedback via transmitting a feedback packet back to the sender application. In some cases, if congestion is no longer being experienced, the network node may eschew forwarding the feedback packet with the ECN it receives from the receiver application.

Hardware processor 502 may avoid marking of the queued data packet with the congestion indication when the queue depth is below the low queue depth threshold. When the queue depth falls below the low queue depth threshold, the network node can be considered capable of handling the data packets being transmitted thereto at the same rate (or better). In this way, unnecessary throttling of packet transmission rates associated with the application flow to which the data packet belongs can be avoided. Avoiding the unnecessary throttling also results in a more stable user experience because transmission rates can stay constant for a longer period of time before being configured differently to address congestion.

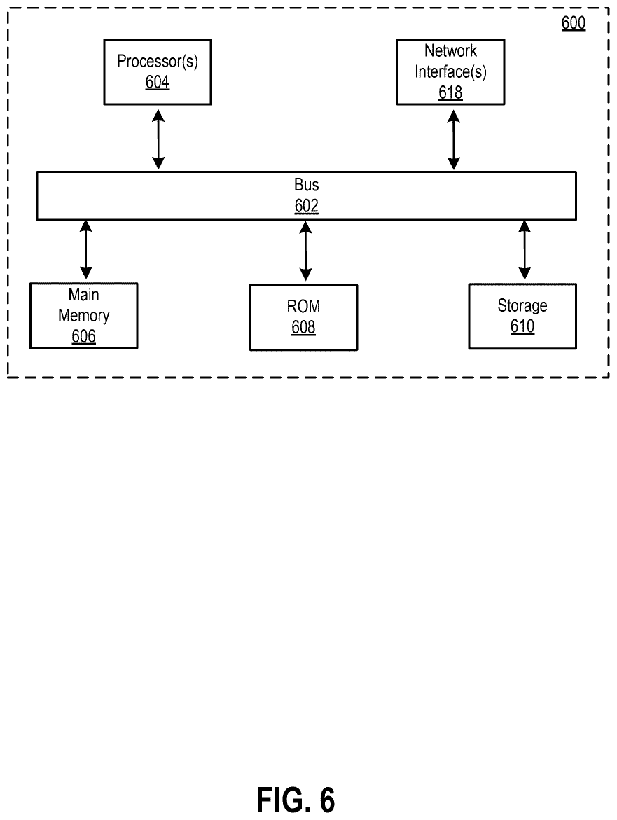

FIG. 6 depicts a block diagram of an example computer system 600 in which various examples of the disclosed technology described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors, such as processors for an AP such as one of APs 106A-C, a node, such as nodes 242-246, for executing applications, such as sender/receiver applications 240/248, etc.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python.

The computer system 600 may implement the techniques described herein using customized hard-wired logic, one or more ASICs or FPGAs, firmware and/or program logic which in combination with the computer system causes or programs computer system 600 to be a special-purpose machine.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606.

Non-transitory media is distinct from but may be used in conjunction with transmission media. Transmission media participates in transferring information between non-transitory media.

The computer system 600 also includes a communication interface 618 coupled to bus 602. Network interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
receiving, at a network node, from a sender application, a data packet;
determining a priority of the data packet, and assigning the data packet to an access category (AC) queue, the AC queue being associated with low and high queue depth thresholds according to which the network node determines when to start or stop marking data packets in the AC queue with a congestion indication; and
processing the data packet for transmission by the network node to a receiver application in accordance with the AC queue.

2. The method of claim 1, wherein the data packet is marked as being associated with an Explicit Congestion Notification (ECF)-capable sender application.

3. The method of claim 1, wherein the network node comprises a bottleneck node at which congestion is being experienced.

4. The method of claim 1, wherein the network node comprises an access point (AP).

5. The method of claim 1, wherein determining the priority of the data packet comprises using a Differentiated Services Control Point (DSCP) value associated with the data packet to determine a traffic ID that is mapped to an AC.

6. The method of claim 1, wherein the processing of the data packet for transmission comprises checking a queue depth of the AC queue.

7. The method of claim 6, wherein the processing of the data packet for the transmission further comprises marking the data packet with the congestion indication when the queue depth exceeds the high queue depth threshold.

8. The method of claim 6, wherein the processing of the data packet for the transmission further comprises avoiding marking of the data packet with the congestion indication when the queue depth is below the low queue depth threshold.

9. The method of claim 1, further comprising adjusting the low queue depth threshold by monitoring radio frequency (RF) conditions on a channel, and based on the monitored RF conditions, setting the low queue depth threshold to allow for more packet traffic to be transmitted or to trigger congestion control earlier.

10. The method of claim 1, further comprising adjusting the high queue depth threshold by monitoring radio frequency (RF) conditions on a channel, and based on the monitored RF conditions, setting the high queue depth threshold to reduce existing congestion or to avoid frequent congestion control actions from being taken.

11. The method of claim 1, further comprising determining whether the received data packet is already marked with the congestion indication.

12. The method of claim 11, further comprising, in response to a determination that the received data packet is already marked with the congestion indication, forwarding a received congestion experienced feedback packet upstream towards the sender application.

13. The method of claim 11, further comprising, in response to a determination that the received data packet is not marked with the congestion indication, determining whether congestion still exists at the network node upon receiving a congestion experienced feedback packet from a downstream node, and either forwarding the congestion experienced feedback packet upstream towards the sender application if congestion still exists, or dropping the congestion experienced feedback packet.

14. A method comprising:
receiving data packets at a network node;
determining respective priorities of the data packets, and assigning the data packets to one or more access category (AC) queues corresponding to the determined priorities of the data packets, the one or more AC queues being associated with respective low and high queue depth thresholds according to which the network node determines when to start or stop marking data packets in the one or more AC queues with congestion indications; and
transmitting the data packets in accordance with the one or more AC queues.

15. The method of claim 14, further comprising checking queue depths of the one more AC queues.

16. The method of claim 15, further comprising marking the data packets with the congestion indications when the queue depths exceed the respective high queue depth thresholds of the one or more AC queues.

17. The method of claim 16, further comprising avoiding marking of the data packet with the congestion indications when the queue depths are below the low queue depth thresholds of the one or more AC queues.

18. The method of claim 14, further comprising, prioritizing marking data packets associated with at least one of best effort and background ACs, over at least one or more of video and voice ACs when the received data packets are associated with two or more concurrently running applications corresponding to different ACs.

19. The method of claim 18, further comprising receiving a congestion experienced feedback packet at the network node, determining whether congestion is still being experienced at the network node, and forgoing forwarding the congestion experienced feedback packet upstream to one or more sender application that transmitted the received data packets.

20. A system, comprising:
a processor; and
a memory comprising instructions, that when executed cause the processor to:
receive a data packet from a sender application;
mark the data packet with a congestion indication when a queue depth of an access category (AC) queue to which the data packet is assigned exceeds a high queue depth threshold associated with the AC queue;
avoid marking the data packet with the congestion indication when the queue depth of the AC queue to which the data is assigned is below a low queue depth threshold associated with the AC queue; and
transmit the data packet to a receiver application in accordance with the AC queue.
